(19) United States
(12) Patent Application Publication
(10) Pub. No.: US 2005/0071240 A1
(43) Pub. Date: Mar. 31, 2005

(54) System and method for purchasing linked with broadcast media

(76) Inventor: Stephen A. Ewald, Tampa, FL (US)

Correspondence Address: ARNALL GOLDEN GREGORY LLP, Suite 2800, 1201 West Peachtree Street, Atlanta, GA, 30309, US

(21) Appl. No.: 10/672,133

(22) Filed: Sep. 26, 2003

(51) Int. Cl. G06F 17/60

(52) U.S. Cl. 705/26

(57) ABSTRACT

A system and method for purchasing goods and services related to broadcast media, such a radio or television broadcast, where a broadcast receiver receives a media including information relating to goods and services that can be purchased by persons receiving the media. A person purchases the goods and services by indicating at the broadcast receiver a desire to purchase, and the broadcast receiver selectively records the purchase data for the goods and services and relays the purchase data to one or more servers that selectively receive and verify the purchase data. The transmission of the purchase data from the receiver can occur at the time of purchase, or at some other predetermined period or location.

### BACKGROUND OF THE INVENTION

1. Field of the Invention

The present invention generally relates to broadcast media and the sale of goods and services using the media. More particularly, the invention relates to a system and method to allow remote purchases of goods and services based upon advertising in broadcast media.

2. Description of the Related Art

Broadcast media, such as radio and television, has been advertising goods and services for audience purchase since the inception of the media. In typical advertising situations, the broadcast media will include a description of the good or service such that the listener or viewer can learn at least the identity or brand name of the good or service and potentially some of the benefits and desirability of purchase. In some instances, the specific physical location where one can purchase the good or service is also disclosed.

More recently, there has been advertisement conducted in broadcast media that is linked with another communication media, such as telephone or Internet access, whereby a person seeing a good or service advertised can affect purchase of the good or service through contacting a sales department through a separate communication media. For example, if a radio listener were to hear a certain service advertised with a telephone number given, he or she could call the telephone number either upon hearing it, or record the number and call at some point thereafter. With the advent and pervasiveness of cellular telephones, persons driving in cars or otherwise remotely listening to broadcast radio can likewise purchase goods or services in this manner. There have also been specific dedicated advertising broadcast channels of media, radio, television, and satellite, which only advertise goods and services for purchase. These channels typically have a dedicated phone number and/or Internet sites for audience purchase, and give a specific identifier to the goods and services being sold, such as a predetermined product code or number, so that the purchaser need only remember the product identifier when calling and not have to recall and give a significant description of the goods or services desired purchased.

These systems of broadcast media advertisements however typically require that the persons in the audience separately contact the seller of the good or service, and remember both the method to contact the seller, i.e. phone number or Internet site, and the description of the goods or service desired purchased, or at least the product identifier code. Further, the person receiving the broadcast media and advertisement may be remotely located from a communication channel, and also may be unable to devote much attention to the purchase of the good or service, such as a person driving a car and listening to advertising on the radio. In such a situation, the difficulty of directly purchasing the good or service, recording the purchase and contact information, or simply remembering the purchase contact information or good or service description, all adversely impact the potential sale of the good or service.

Another problem encountered in advertising accompanying broadcast media is that there often exists other media transmitted in the broadcast media that may be available for purchase but no specific advertising or identifying material for media is in the broadcast to alert the potential purchaser of the purchasing ability. An example is a song being broadcast over the radio where the song's title or artist has not been separately announced such that a listener can identify the song for purchase. In such instance, the listener or potential purchaser must take extra action to both learn of the purchase information for the specific good or service contained in the broadcast media, and then learn where to actually purchase the good or service.

Accordingly, it would be advantageous to provide a system and method to allow a person hearing and/or seeing broadcast media to easily make a purchase for a good or service advertised within the broadcast media without having to resort to a secondary communication. Once the person has indicated a desire to purchase, the system and method should not require further interaction from the person to verify or follow through with the purchase. Further, the system and method should allow the purchase of goods and services identified within the broadcast media even if specific identification data for the purchase has not been explicitly given. It is thus to the provision of such a system and method of providing a remotely accessible diagnostic interface that the present invention is primarily directed.

### SUMMARY OF THE INVENTION

The present invention is a system and method for purchasing goods and services related to broadcast media, such a radio or television broadcast, where a broadcast receiver receives a media including information that relates to goods and services that can be purchased by persons receiving the media. The receiver allows a person to purchase the goods and services by allowing a person to indicate a desire to purchase, such as by simply pressing a button on a radio receiver, and then selectively records the purchase data for the good and service and relays the purchase data to one or more servers that selectively receive and verify the purchase data. The transmission of the purchase data from the receiver can occur at the time of purchase, via a communication with another device, or at some other predetermined period wherein all stored purchase data is sent to the device where the purchase is completed.

The method for purchasing goods and services related to broadcast media particularly includes the steps of receiving at a broadcast receiver a broadcast media including information relating to goods and services that can be purchased by persons receiving the media, selectively recording purchase data at the broadcast receiver for a good and service that a person purchases relating to the broadcast media, sending the purchase data from the broadcast receiver to at least one server, receiving the purchase data at the at least one server, and verifying the purchase data from the broadcast receiver at the least one server. The method can include the step of storing the purchase data and then transmitting the stored purchase data to a server at a predetermined period, such as when the receiver is able to communicate with the server or another computer device.

It is therefore an object of the system and method to provide a system and method to allow a person receiving a broadcast media at a remote receiver to make a purchase for a good and/or service advertised within the broadcast media. The person can indicated a desire to purchase the good or service, such as through simply pressing a button or actuating a switch, and no further interaction is preferably required with the person to make the purchase. Moreover, the broadcast receiver can allow the purchase of goods and services that are identified within the broadcast media, such as a song, even if specific advertising for the purchase has not occurred so long as proper identifying data is within the stream of broadcast media.

Other objects, advantages, and features of the present invention will become apparent after review of the hereinafter set forth Brief Description of the Drawings, Detailed Description of the Invention, and the Claims.

### BRIEF DESCRIPTION OF THE DRAWINGS

FIG. 1 is a representative diagram of one embodiment of a system with the broadcast receiver for a broadcast media selectively communicating with a server, and potentially other computer devices, to purchase goods and services advertised within the broadcast media.

FIG. 2 is a perspective view and block diagram of one embodiment of the broadcast receiver.

FIG. 3 is a flowchart of the process executing on the broadcast receiver to purchase goods or services linked with the received broadcast media.

FIG. 4 is a flowchart of the process executing on the server that receives purchase data from the broadcast receivers.

### DETAILED DESCRIPTION OF THE INVENTION

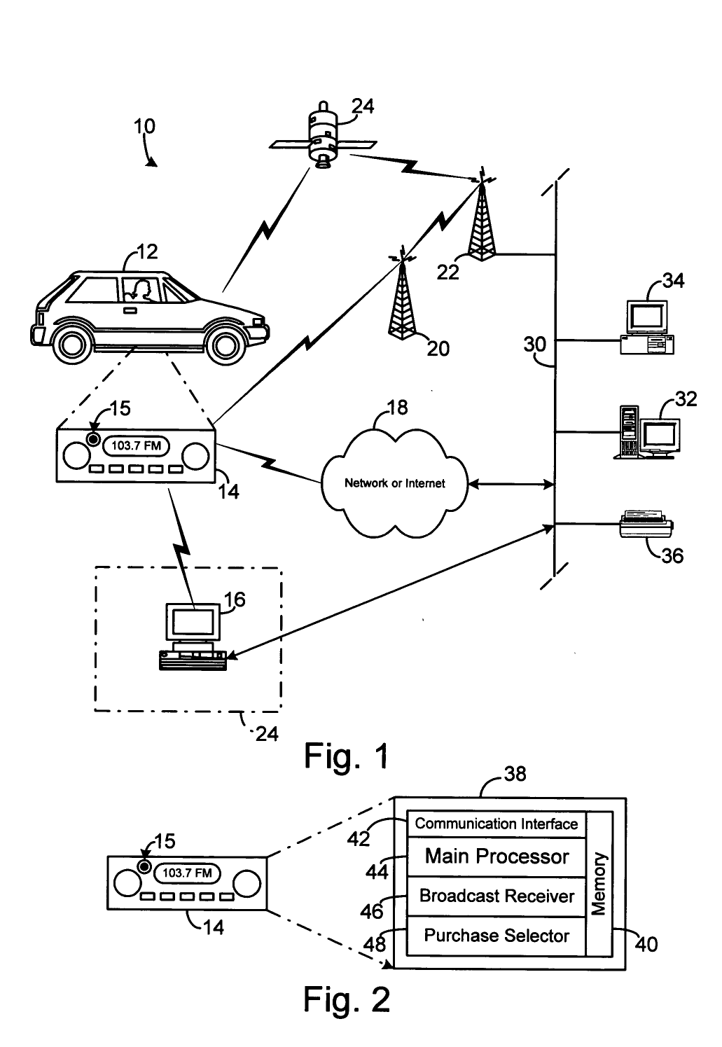

With reference to the figures in which like numerals represent like elements throughout, FIG. 1 illustrates one embodiment of a system 10 with the broadcast receiver 14 shown in an automobile 12 for a broadcast media, such as radio. The receiver 14 selectively communicates with a server 32, and potentially other computer devices, such as second computer 34 or other mobile communication devices such as PDAs, cellular telephones, and personal computers, to purchase goods and services advertised within the broadcast media. In the system 10, one or more broadcast receivers 14 receive broadcast media, such as a radio signal from broadcast tower 20, and the media includes information relating to goods and services, such as songs or service advertisement, that can be purchased by persons receiving the media.

In this embodiment, the receiver 14 includes an indicator button 15 or other means so that the person can simply indicate the desire to purchase a good or service while that service is advertised in the broadcast media. As an example, if a listener hears a song played on the radio, he or she presses the button 15 to purchase the album that contains that song. The broadcast receiver 14 will inform the person if purchase is not available through an audible and/or visual alert after pressing the button 15. Once the button 15 is pressed, the broadcast receiver further records the purchase data and then transmits the purchase data to one or more servers, such as server 32 and 34, which selectively receive and verify purchase data sent from the one or more receivers 14.

The system 10 is shown as having several potential avenues of communication between the broadcast receiver 14 at the automobile 12 and the one or more servers 32 and 34. At the time the purchase data is received, the broadcast receiver 14 can communicate directly to a server, such as server 32, through wireless network or internet connection 18, through a radio relay such as a communication with a satellite 24 which then relays the purchase data to a separate receiver 22 that communicates the data to a LAN 30 or other network where it is accessible to the server 32. The broadcast receiver 14 can also directly communicate with the receiver 22 of the LAN 30. Also shown on the LAN 30 side is a printer 36, which can include other immediate printing or outputting means once the purchase data is received server-side.

If embodied so as to store the purchase data, as is further described herein, the broadcast receiver 14 will store the purchase data and then transmit the stored data at a predetermined time or location. For example, the broadcast receiver 14 can store the purchase data and then when the automobile 12 is in range of the wireless network or line-of-sight communication of the home computer 16 at the home 24, a wireless communication can be made whereby the broadcast receiver 14 transmits the purchase data to the home computer 16 and the home computer 16 then transmits the purchase data to the server 32 or server-side LAN 30. Alternately, the broadcast receiver 14 can simply store the purchase data until it is in range of the server-side receiver 22, or can send the purchase data at a predetermined time so that the server-side devices are anticipating receipt of any purchase data, e.g. all purchase data is sent at 6 pm. Once the purchase data is verified, the delivery of the good or service can be accomplished through any method known in the art, such as mail, courier, direct download or electronic transaction, follow up communication, or other delivery method.

The components of the broadcast receiver 14 are more particularly shown in the block diagram of FIG. 2. The broadcast receiver 14 includes a computer platform 38 with a main processor 44, such as those manufactured by Intel®, Motorola®, or Texas Instruments®, performing all central logic, as is known in the art, and a memory 40 is present to store and forward data from any component as necessary. On the platform 38 is the broadcast receiver 46 for receiving the broadcast media, which can be radio, television, shortwave, or other digital or analog over-the-air signals. There is also a purchase selector 48 that communicates with the communications interface 42 to transmit the purchase data to another computer device, such as server 32. The purchase selector 48, in this embodiment, interfaces with the selection button 15 to determine when a person desires to purchase a good or service in the broadcast media. The main processor 44 can determine whether or not identification data is present in the broadcast media data stream so that the good or service can be identified for purchase. However, any of the components shown can include logic sufficient to perform any step or function as described herein.

The identification data is typically in-band, within the broadcast media stream, so that a separate communication channel to communication the identification data is unnecessary. An example is a data frame at the beginning of a song that the receiver 14 records so that if the song is selected for purchase during its broadcast, the receiver 14 will have the identification data readily available. Thus, upon the next song being played, the new frame is loaded, or if no frame is present, the receiver does not attempt purchase of the song even if requested. Alternately, the broadcast receiver 14 can include logic to gather data from other components, such as the specific broadcast receiver 46 as to the channel currently being monitored, and if the time is also recorded, the relay of the channel and time within the purchase data can be looked up at the server 32 to determine the identification of the good or service desired purchased.

The purchase data will include at least the identification of the purchaser, such as a code, token, MIN, Pin number, or other indicia, and data sufficient to identify the good or service desired purchase. If the purchase data is not immediately transmitted from the broadcast receiver 14 when created, it can be stored in the memory 40 and transmitted through the communication interface 42 at a predetermined location or time. The broadcast receiver 14 can include any wired or wireless means of communication for the communication interface 42 as known in the art, such as radio frequency (RF) and infrared (IR) communications, to communicate with the server 32, home computer 16, receiver 22, or satellite 24, or any other computer device.

While the broadcast receiver 14 is shown here as a single device on a platform 38, the broadcast receiver 14 can be comprised of several devices, each of which can perform one or more functions as stated herein. In one embodiment, a separate device for the purchase selector 48 and communication interface 42 that communicates with a separate broadcast receiver 46, either by a wired or wireless connection, and can extract any information data that is in the broadcast media otherwise being received by the broadcast receiver 14 such that the person can purchase the good or service being advertised. For example, if the broadcast receiver 46 is a home stereo, the separate purchase selector 48 and communication interface 42 could be placed either in proximity to the home stereo or connected thereto and when a listener hears a good or service advertised in the radio broadcast, he or she can activate the purchase selector 48 to purchase the good or service in the manner described herein.

One advantage of the present system 10 is that the broadcast media does not have to overtly and explicitly include information about the purchase of the goods and services. As an example, if the broadcast media is a radio broadcast, each song does not have to include an advertisement of its identity or even state that it is available for purchase to the user of the broadcast receiver 14. As long as the broadcast media includes identification data such that the broadcast receiver can identify the good or service desired to be purchased, the person can simply indicate a desire to purchase, such as pressing button 15, and the broadcast receiver 14 will inform the person if the good or service is not purchasable using the system 10. Thus, the broadcast media is not required to include any explicit information in the broadcast media stream about the purchase of the goods and services. It should also be noted that the good or service can be a tangible good or service, such as purchase of an album or ticket to a concert, or can be another payment or secure transaction, such as a donation to a cause or a political contribution.

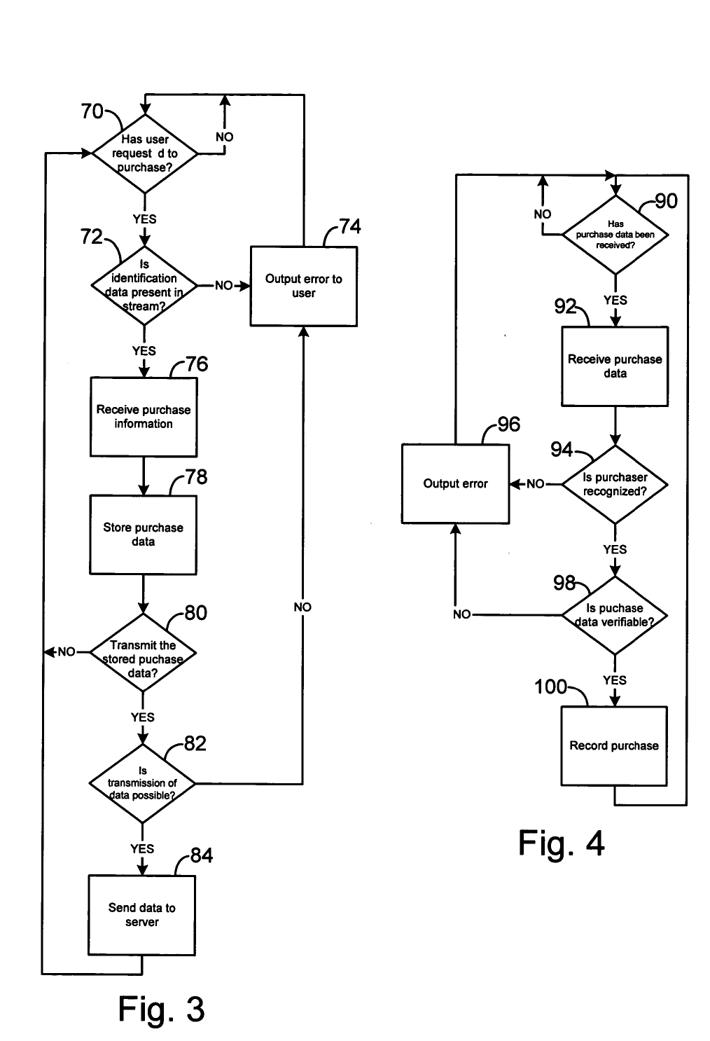

FIG. 3 is a flowchart of the process executing on the broadcast receiver 14 to purchase goods or services linked with the received broadcast media. The broadcast receiver 14 makes a determination as to whether the user has requested to purchase a good or service, as shown at decision 70. If no purchase has been indicated at decision 70, then the process reiterates such that the broadcast receiver 70 is in a wait state for user input. Otherwise, if the user requests to purchase at decision 70 (i.e. pressed button 15), a determination is then made as to whether identification data is present in the broadcast data stream such that the good or service desired to be purchased can be identified, as shown at decision 72. If there is no identification data present at decision 72, then an error is output to the user, as shown at step 74, and then process returns to decision 70.

Otherwise, if the identification data is present in the broadcast media stream at decision 72, the purchase information is received, as shown at step 76, and the purchase data is then generated and stored at step 78. While this embodiment stores the data in memory 40, step 78 is not necessary if immediate transmission of the purchase data is effected. A determination is then made as to whether the purchase data should be transmitted, as shown at decision 80, which can be a decision as to whether a period has elapsed or transmission of the purchase data at that time is otherwise desirable. If the transmission of the purchase data is not indicated at decision 80, then the process returns to decision 70 to await further user input. Otherwise, if transmission of the purchase data is indicated at decision 80, then a determination is made as to whether the transmission of the purchase data is possible at that moment, as shown at decision 82. If the transmission of the purchase data is not possible at decision 82, then an error is outputted to the user at step 74 and the process returns to decision 70 to await user input. Or, if the transmission of the purchase data is possible at decision 82, then the purchase data is sent to the server 32, as shown at step 84, and then the process returns to decision 70 to await user input.

FIG. 4 is a flowchart illustrating one embodiment of the process executing on the server 32 that receives purchase data from the broadcast receiver 14. This embodiment of the server 32 awaits the receipt of purchase data, and thus a determination is first made as to whether purchase data has been received from the broadcast receiver 14, as shown at decision 90. The server 32 can alternately be embodied so as to poll or request the broadcast receivers 14 send any stored purchase data. If no purchase data has been received at decision 90, then the process iterates at decision 90 to await purchase data. Otherwise, if purchase data has been received at decision 90, then purchase data is received as shown at step 92, and then a determination is made as to whether the purchaser is recognized as shown at decision 94.

The recognition of the purchaser can be from a specific database of purchasers, such as those signed up for the service, or those otherwise identifiable to the server 32 based upon the purchase data. As an example, a purchaser signs up at a website and pre-purchases songs, and the server 32 will recognize the purchaser and credit the song accordingly. Another example is a credit card number being located in the purchase data send from the broadcast receiver 14. In this embodiment, the user of the broadcast receiver 14 inputs his or her credit card data at a convenient time and the receiver 14 stores the credit card data and transmits it with the purchase data sent when the purchase selection indicator 15 is actuated. The server 32 can then identify the purchaser upon receipt of the credit card data.

If the purchaser is not recognized at decision 94, then an error is output, either to an operator of the server 32 or a general error can be thrown in the Server OS, as shown at step 96 and the process returns to decision 90 to await the receipt of purchase data. Otherwise, if the purchaser can be recognized at decision 94, then a decision is made as to whether the purchase data is verifiable as shown at decision 98. If the purchase data is not verifiable at decision 98, then an error is output at step 96 and the process returns to decision 90 to await purchase data receipt. Otherwise, if the purchase data is verifiable at decision 98, in conjunction with the purchaser being recognized at decision 94 (a precondition), the purchase is recorded at step 100, and the process returns to decision 90 to await further purchase data.

It should be appreciated that decisions 94 and 98 can be combined, and other determinations can be made before the purchase data is accepted. Moreover, the link between the broadcast receiver 14 to the server 32 from step 84 to step 92 can be a SSL or other type of secure link so that the purchase data is secure.

It can thus be seen that the system 10 provides an inventive method for purchasing goods and services linked with broadcast media, such as radio broadcasts, including the steps of receiving at a broadcast receiver 14 a broadcast media including information relating to goods and services that can be purchased by persons receiving the media, selectively recording purchase data at the broadcast receiver 14 for a good and service that a person purchases relating to the broadcast media, sending the purchase data from the broadcast receiver 14 to at least one server, such as server 32; receiving the purchase data at the at least one server 32, and verifying the purchase data sent from the broadcast receiver 13 at the least one server 32. The step of sending the purchase data can be sending the purchase data to a plurality of servers, such as servers 32 and 34, and then the method can further include the step of storing the purchase data at one of the servers, such as server 32, and then the step of verifying the purchase data occurs at a different server, such as server 34.

The step of sending the purchase data can be sending the purchase data from the broadcast receiver 14 to the server 32 via a secure communication channel, such as through a SSL or other data encryption method. The method can further include the steps of storing the purchase data at the broadcast receiver 14, such as in memory 40, and then transmitting the stored data from the broadcast receiver 14 to the server 32 when the broadcast receiver 14 is at a predetermined location, such as at home 24 or near the receiver 22. The method can also include the steps of storing the purchase data at the broadcast receiver 14, and transmitting the stored data from the broadcast receiver 14 to the server 32 at a predetermined period of time.

Further, the step of receiving at a broadcast receiver 14 a broadcast media receiver can be receiving a radio signal at a radio receiver, such as shown in the broadcast receiver 14 of FIG. 2. And the step of receiving at a broadcast receiver 14 a broadcast media can be receiving a broadcast media that either includes or does not include information about the purchase of goods and services contained within the broadcast media, with the broadcast receiver 14 informing the user should purchase not be possible.

In the context of FIGS. 3 and 4, the present method may be implemented, for example, by operating portion(s) of the broadcast receiver 14, such as main processor 44, and server 32 to execute a sequence of machine-readable instructions. The instructions can reside in various types of signal-bearing or data storage primary, secondary, or tertiary media. The media may comprise, for example, RAM (not shown) accessible by, or residing within, the components of the network 18 or LAN 30. Whether contained in RAM, a diskette, or other secondary storage media, the instructions may be stored on a variety of machine-readable data storage media, such as DASD storage (e.g., a conventional “hard drive” or a RAID array), magnetic tape, electronic read-only memory (e.g., ROM, EPROM, or EEPROM), flash memory cards, an optical storage device (e.g. CD-ROM, WORM, DVD, digital optical tape), paper “punch” cards, or other suitable data storage media including digital and analog transmission media. Furthermore, any functions stated herein can be implemented in hardware, software, or firmware with digital logic and/or software code as would be apparent to one of skill in the art.

While the foregoing disclosure shows illustrative embodiments of the invention, it should be noted that various changes and modifications could be made herein without departing from the scope of the invention as defined by the appended claims. Furthermore, although elements of the invention may be described or claimed in the singular, the plural is contemplated unless limitation to the singular is explicitly stated.

1. A system for purchasing goods and services linked with broadcast media, comprising:
one or more broadcast receivers that receive a broadcast media including information relating to goods and services that can be purchased by persons receiving the media, the receiver further selectively recording the purchase data for goods and services that a person purchases relating to the broadcast media; and
one or more servers that selectively receive and verify purchase data sent from the one or more receivers.

2. The system of claim 1, wherein the broadcast is in communication with a server.

3. The system of claim 1, wherein the broadcast receiver stores the purchase data and transmit the stored purchase data at a predetermined location.

4. The system of claim 1, wherein the broadcast receiver includes a radio.

5. The system of claim 1, wherein the broadcast media includes information about the purchase of the goods and services

6. The system of claim 1, wherein the broadcast media does not include information about the purchase of the goods and services.

7. The system of claim 1, wherein the broadcast receiver is a single device.

8. The system of claim 1, wherein the broadcast receiver is comprised of at least two devices, to include a broadcast media receiver and a purchase selection device.

9. A broadcast receiver for purchasing goods and services linked with broadcast media, the broadcast receiver receiving a broadcast media including information relating to goods and services that can be purchased by persons receiving the media, the broadcast receiver further selectively recording the purchase data for goods and services that a person purchases linked with the broadcast media and selectively transmitting the purchase data to another computer device.

10. The broadcast receiver of claim 9, further comprising a purchase selection indicator.

11. The broadcast receiver of claim 9, wherein the broadcast receiver further stores the purchase data and transmits the stored data at a predetermined location.

12. A method for purchasing goods and services linked with broadcast media, comprising the steps of:
receiving at a broadcast receiver a broadcast media including information relating to goods and services that can be purchased by persons receiving the media;
selectively recording purchase data at the broadcast receiver for a good and service that a person purchases relating to the broadcast media;
sending the purchase data from the broadcast receiver to at least one server;
receiving the purchase data at the at least one server; and
verifying the purchase data from the broadcast receiver at the least one server.

13. The method of claim 12, wherein:
the step of sending the purchase data is sending the purchase data to a plurality of servers; and
further comprising the step of storing the purchase data of one of the servers; and
wherein the step of verifying the purchase data occurs at a different server.

14. The method of claim 12, wherein the step of sending the purchase data is sending the purchase data from the broadcast receiver to the server via a secure communication channel.

15. The method of claim 12, further comprising the steps of:
storing the purchase data at the broadcast receiver; and
transmitting the stored data from the broadcast receiver to the server when the broadcast receiver is at a predetermined location.

16. The method of claim 12, further comprising the steps of:
storing the purchase data at the broadcast receiver; and
transmitting the stored data from the broadcast receiver to the server at a predetermined period of time.

17. The method of claim 12, wherein the step of receiving at a broadcast receiver a broadcast media receiver is receiving a radio signal at a radio receiver.

18. The method of claim 12, wherein the step of receiving at a broadcast receiver a broadcast media is receiving a broadcast media that includes information about the purchase of goods and services contained within the broadcast media.

19. The method of claim 12, wherein the step of receiving at a broadcast receiver a broadcast media is receiving a broadcast media that does not include information about the purchase of goods and services contained within the broadcast media.
